(19) United States
(12) Patent Application Publication
(10) Pub. No.: US 2026/0061359 A1
(43) Pub. Date: Mar. 5, 2026

(54) SOLID SORBENT HEAT EXCHANGE AND/OR DESORPTION

(71) Applicant: Mosaic Materials, Inc., Alameda, CA (US)

(72) Inventors: Samuel Cheng, Katy, TX (US); Steven Craig Russell, The Woodlands, TX (US)

(21) Appl. No.: 18/819,580

(22) Filed: Aug. 29, 2024

(51) Int. Cl. B01D 53/04

(52) U.S. Cl. CPC B01D 53/0446; B01D 53/0438; B01D 2257/504; B01D 2259/4009; B01D 2259/40098

(57) ABSTRACT

A system includes a vessel configured to receive a thermal energy source or air, and a plurality of passageways disposed in the vessel. The plurality of passageways are configured to hold a solid sorbent, the plurality of passageways causing the thermal energy source to exchange heat with the solid sorbent, or causing the air to interact with the solid sorbent. Each passageway includes a wall having a porous structure configured to prevent the solid sorbent from passing through the wall while allowing a fluid to pass through the wall.

### BACKGROUND

In the resource recovery and fluid sequestration industries, as well as other industries, sorbents are used to remove gases, vapors, and other components from fluids (e.g., flue gas, air, etc.) via adsorption (e.g., direct air capture). For example, adsorption systems such as carbon capture systems may capture carbon dioxide via adsorption with sorbents. The sorbents may then be fed to a desorption system to remove desired components.

### SUMMARY

An embodiment of a system includes a vessel configured to receive a thermal energy source or air, and a plurality of passageways disposed in the vessel. The plurality of passageways are configured to hold a solid sorbent, the plurality of passageways causing the thermal energy source to exchange heat with the solid sorbent, or causing the air to interact with the solid sorbent. Each passageway includes a wall having a porous structure configured to prevent the solid sorbent from passing through the wall while allowing a fluid to pass through the wall.

An embodiment of a system for heat exchange includes a vessel configured to receive a thermal energy source or air; and a plurality of passageways disposed in the vessel. The plurality of passageways are configured to hold a solid sorbent, the plurality of passageways causing the thermal energy source to exchange heat with the solid sorbent, or causing the air to interact with the solid sorbent. The vessel includes a set of baffles configured to distribute a flow of a convection fluid through the vessel.

An embodiment of a method includes receiving a thermal energy source or air, and directing the thermal energy source or the air to an interior of a vessel. The vessel includes a plurality of passageways, where each passageway of the plurality of passageways includes a wall having a porous structure configured to prevent a solid sorbent from passing through the wall while allowing a fluid to pass through the wall. The method includes introducing a solid sorbent and holding the solid sorbent within the plurality of passageways and the vessel, the plurality of passageways causing the thermal energy source to exchange heat with the solid, or causing the air to interact with the solid sorbent.

### BRIEF DESCRIPTION OF THE DRAWINGS

The following descriptions should not be considered limiting in any way. With reference to the accompanying drawings, like elements are numbered alike:

FIG. 1 schematically depicts an embodiment of an adsorption and desorption system, such as a carbon capture system, configured as a moving sorbent system and used to remove gas or other material from a sorbent;

FIGS. 2A-2C depict an embodiment of an adsorption and desorption system, and aspects of a method that includes using the system to remove gas or other material from a sorbent;

FIGS. 3A-3C depict an embodiment of a stationary sorbent bed adsorption and desorption system, and aspects of a method that includes using the system to remove gas or other material from a sorbent

FIGS. 4A-4C depict an embodiment of a moving sorbent bed adsorption and desorption system, and aspects of a method that includes using the system to remove gas or other material from a sorbent

FIG. 5 is a cross-sectional view of an embodiment of an adsorption and/or desorption system;

FIG. 6 is a perspective view of an embodiment of a heat exchanger of the system of FIG. 5, the heat exchanger including porous tubes configured to enclose a solid sorbent in the heat exchanger;

FIGS. 7A and 7B depict examples of a porous structure of a wall of a tube of the heat exchanger of FIGS. 5 and 6;

FIG. 8 is a perspective view of an embodiment of a heat exchanger of the system of FIG. 5, the heat exchanger including porous plates configured to enclose a solid sorbent in the heat exchanger;

FIGS. 9A and 9B depicts an example of a fluid path defined by the plates of FIG. 8;

FIG. 10 is a cross-sectional view of an embodiment of a heat exchanger configured to heat a solid sorbent via a heat exchange fluid;

FIG. 11 is a cross-sectional view of an embodiment of a heat exchanger configured to heat a solid sorbent via electromagnetic energy; and

FIG. 12 is a cross-sectional view of an embodiment of a heat exchanger configured to heat a solid sorbent via electromagnetic induction or conduction.

### DETAILED DESCRIPTION

A detailed description of one or more embodiments of the disclosed apparatus and method are presented herein by way of exemplification and not limitation with reference to the Figures.

Systems and methods are provided for heat transfer and/or capture of desired components, such as carbon dioxide. An embodiment of a heat transfer system includes a heat exchanger configured to receive a solid sorbent, and exchange heat between the sorbent and a thermal energy source, such as a heat exchange fluid. In an embodiment, the solid sorbent is at least partially saturated with carbon dioxide, and the heat exchanger is configured to heat the saturated sorbent to release the carbon dioxide. The released carbon dioxide may then be flowed to a containment vessel or other suitable location or sequestration, storage or further use.

The heat exchanger includes a plurality of passageways that may direct the solid sorbent through the heat exchanger while the thermal energy source (e.g., carbon dioxide gas or other heat exchange fluid) is directed into the heat exchanger. The plurality of passageways are defined by tubes, plates, or other desired components having sizes selected so that solid sorbent (e.g., bulk solid, such as sorbent granules and/or pellets) can move through the passageways. Walls of the passageways have a porous structure that allows a circulating fluid to enter the passageways and/or come into contact with the solid sorbent. The porous structure is configured to prevent the solid sorbent from passing through the walls. In addition, the porous structure is configured to allow any gases or fluids released from the solid sorbent to flow through the walls (e.g., so that released fluids can be more efficiently removed from the heat exchanger). As described herein, a “porous” structure refers to a property that allows a fluid or gas to pass through the structure, and is not intended to denote any specific configuration.

Embodiments described herein provide for a number of advantages. For example, the porous structure of the walls of the passageways allows for improved heat transfer between a solid sorbent and fluid. In addition, if the solid sorbent is heated to release captured gas or other material (e.g., adsorbed carbon dioxide and/or water), the porous structure facilitates removal of the release material, thereby improving the efficiency of carbon capture and other capture processes. Furthermore, the embodiments allow for waste heat to be recovered to reduce net power consumption.

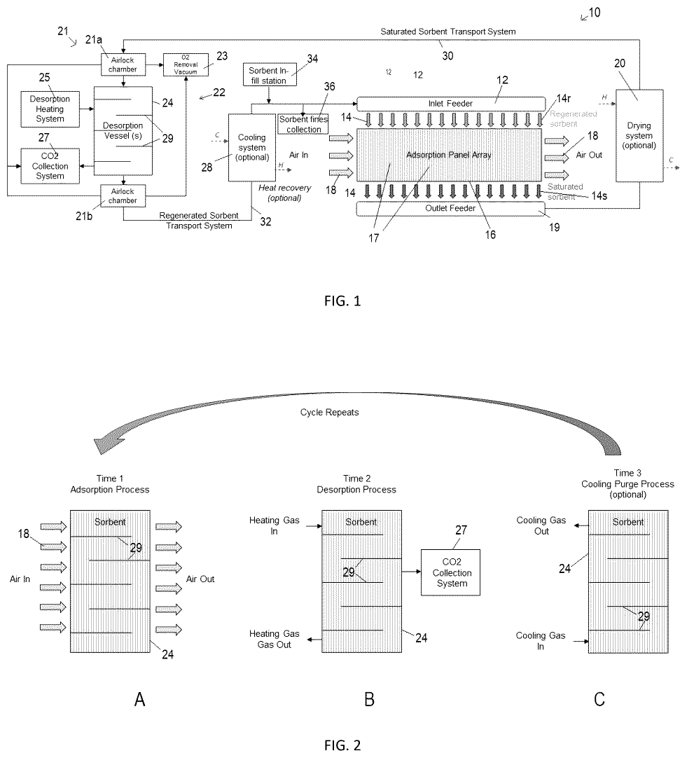

Embodiments described herein are applicable with any suitable type of solid sorbent or combination of solid sorbents, as well as any suitable system that utilizes solid sorbents to capture components from air or fluids. FIG. 1 schematically depicts an example of an adsorption system used to remove carbon from a fluid, such as ambient air, flue gas or other fluid containing carbon.

FIGS. 1, 2A-2C, 3A-3C and 4A-4C depict examples of a carbon capture system 10 for removing carbon dioxide from air using direct air capture. The system 10 utilizes a solid sorbent that is exposed to air and adsorbs carbon dioxide. Embodiments may be employed with any suitable adsorption, desorption and capture processes and systems. Thus, embodiments are not limited to the specific processes described in FIGS. 1, 2A-2C, 3A-3C and 4A-4C.

Referring to FIG. 1, the system 10 is configured as a moving sorbent system in which a solid sorbent 14 moves as adsorption and desorption of the solid sorbent occurs. In this example, the system 10 includes a feeder 12, such as a hopper or drop spreader, that receives a supply of a solid sorbent 14 that is packaged as a bulk solid (e.g., pellets or granules), or otherwise configured so that the solid sorbent 14 can be moved through the system 10. For example, the solid sorbent 14 is a metal organic framework (MOF), but is not so limited. Other examples of solid sorbents include activated carbon and zeolites.

The sorbent may be or include, for example, metal-organic frameworks, Zeolites, amine-impregnated porous materials, amine-functionalized porous materials, or a combination of one or more of the above. The sorbent may be or include another sorbent known in the art or a combination of sorbents including those known in the art.

The solid sorbent 14 (e.g., regenerated sorbent 14r) is fed via the feeder 12 to one or more adsorption chambers 16. In this example, an adsorption chamber 16 includes an array of filter panels 17; however, the system 10 may include any adsorption chamber configuration. Air 18 flows through the adsorption chamber 16 and the panels 17, where carbon dioxide molecules are adsorbed to the solid sorbent and fall or otherwise move to an outlet feeder 19. Upon saturation with carbon dioxide and/or water, saturated sorbent 14s may be transferred to an optional drier 20 for removal of any captured water.

The dried saturated sorbent 14s is then provided to a desorption system 22 for removal of the captured carbon dioxide. The desorption system 22 includes a feeder (not shown), such as a conical hopper, which feeds the saturated dried sorbent 14s to passageways (not shown) within a desorption vessel 24 (or multiple desorption vessels 24). The passageways hold respective portions of the sorbent 14s and may direct the sorbent in a selected direction, such as a vertical direction or direction of gravity. The saturated sorbent 14s is desorbed by applying thermal energy from a heating system 25 to the sorbent 14s, and desorbed carbon dioxide gas may be removed from the vessel 24 to a collection system 27.

The desorption vessel may include a set of (i.e., one or more) baffles 29 for directing a heating fluid in a cross-flow manner (or any other manner that effectively distributes the thermal energy). In an embodiment, the set of baffles 29 is a plurality of baffles 29 configured to cause the fluid to flow across the plurality of passageways. “Across” in this context refers to a direction that is at least partially perpendicular to the vessel walls and/or passageways.

In an embodiment, the desorption vessel 24 is connected to one or more airlock assemblies 21. Each airlock assembly 21 is configured to isolate an amount of sorbent (e.g., an amount of the saturated sorbent 14s) during a process in which the amount of sorbent is introduced to the desorption vessel 24, and/or during a process in which the amount of sorbent (e.g., regenerated solid sorbent 14r) is removed from the desorption vessel 24. Each airlock assembly 21 includes an airlock chamber (not shown) defined by chamber walls and a pair of airlock valves (not shown).

For example, as shown in FIG. 1, two airlock assemblies 21 are connected to the vessel 24, denoted as an input airlock assembly 21a located upstream of the vessel 24, and an output airlock assembly 21b located downstream of the vessel 24. The airlock chamber of a respective assembly can be evacuated to establish a partial vacuum (i.e. a pressure that is less than an atmospheric pressure) via a vacuum pump 23

The airlock assemblies 21 isolate the main desorption process from atmosphere during the feeding and discharging of the sorbent into and out of the vessel 24. The input and output airlock assemblies 21a and 21b are in communication with the oxygen removal vacuum system 23 and the collection system 27. The airlock assemblies function to prevent escape of gases (e.g., an injected gas and CO2 or other gas released from the solid sorbent) from the vessel 24 during desorption. The input airlock assembly 21a also removes oxygen from the system prior to being injected into the desorption vessel to increase the purity of collected CO2 or other collected gas. The input airlock assembly 21a, used in conjunction with the oxygen removal system 23, removes oxygen surrounding the solid sorbent 14s within the closed volume of the airlock assembly 21a. The removal of the oxygen proximate the solid sorbent 14s, prior to discharging into the desorption vessel 24, prevents oxygen contamination of the desorption vessel working fluid; increasing the purity of the collected CO2 or other collected gases. The output airlock assembly 21b also increases CO2 production by enabling a vacuum desorption process.

After desorption, regenerated solid sorbent 14r is fed to a conveyor or other mechanism (e.g., tubular conveyor, conveyor belt, bucket elevator conveyor) for return to the feeder 12. The desorption system 22 includes, or is connected to, a cooling system 28 for recovering waste heat from the desorption process. The waste heat may be used to heat a gas or fluid used for heat exchange in the desorption system 22.

The system 10 may include other components, including a transport system 30 for transporting saturated sorbent 14s to the desorption vessel 24, and a transport system 32 for transporting regenerated sorbent 14r from the desorption vessel 24 to the inlet feeder 12. Other components may include a sorbent in-fill station 34 for adding lean sorbent to the regenerated sorbent 14r to account for losses due to sorbent attrition and generation of fines (i.e., sorbent particles that are too small to be re-used). A sorbent fines collection station 36 may be included for filtering or removing sorbent fines for collection and/or recycling.

FIGS. 2A-2C depict an example in which the system 10 is a stationary vessel system. In this example, the vessel 24 is used for both adsorption and desorption (i.e., is an adsorption and desorption vessel). Although a single vessel 24 is shown, it is to be understood that the system 10 may include any number of vessels.

FIGS. 2A-2C also correspond to stages of a carbon capture (or other material capture) process, including an adsorption stage (FIG. 2A), a desorption stage (FIG. 2B) and an optional cooling and/or heat recovery stage (FIG. 2C). Use of the system in this example may include any number of repeated cycles.

During a cycle, referring to FIG. 2A, a solid sorbent is disposed within the vessel 24 (e.g., by filling passageways in the vessel 24, adding cartridges or other sorbent packages, etc.). Air 18 is directed to the vessel 24 and flows through the vessel 24, where carbon dioxide is removed from the air 18 by adsorption to the sorbent. Thermal energy, such as a heating gas, is applied to heat the saturated sorbent and collect desorbed carbon dioxide (FIG. 2B). Optionally, regenerated sorbent is cooled as shown in FIG. 2C, before repeating the cycle.

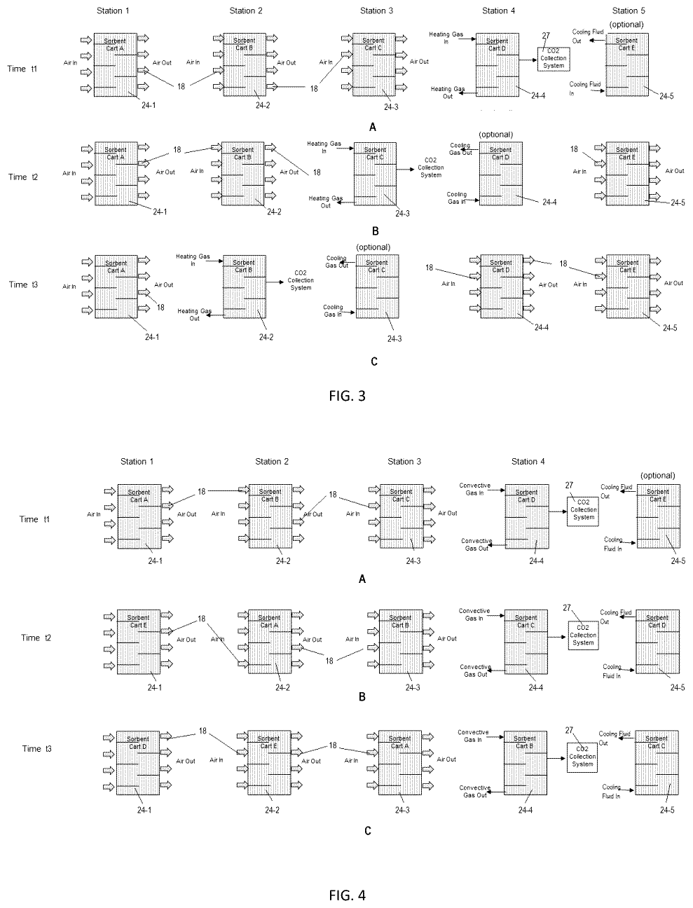

FIGS. 3A-3C depicts an example in which the system includes a plurality of vessels 24 (denoted as vessels 24-1 through 24-5). FIGS. 3A-3C show a state of the vessels at successive times during a carbon capture process. At the onset of the process, a solid sorbent is disposed in each of the vessels 24. In this example, the vessels remain stationary and the process changes with time at each vessel.

In this example, the system is configured as a stationary bed adsorption and desorption system. In this system, sorbent is retained in a vessel and remains stationary during a desorption and/or adsorption process.

At a first time t₁ (FIG. 3A), the vessels 24-1, 24-2 and 24-3 function as “adsorption stations,” and air 18 is directed to flow through each vessel 24-1, 24-2 and 24-3 to adsorb carbon dioxide from the air 18. The vessel 24-4 functions as a “desorption station” at time t₁, in that a heating gas and/or other source of thermal energy is applied to the vessel 24-4 to desorb and collect carbon dioxide. Also at time t₁, the vessel 24-5 is optionally cooled (and waste heat may be collected). Although cooling is shown as being accomplished using air 18, any suitable cooling fluid or gas may be used.

At time t₂, the vessel 24-3 is subject to heating and desorption, while air 18 is flowed through the vessels 24-1, 24-2 and 24-5 for adsorption. The vessel 24-4 may be subject to cooling if desired. In this way, the desorption station is “moved” from the vessel 24-4 to 24-3.

Similarly, at time t₃, desorption moves to the vessel 24-2 (the vessel 24-2 now functions as a desorption station), the vessel 24-3 is optionally cooled, and the vessels 24-1, 24-4 and 24-5 are subject to adsorption. At each successive time following time t₃, the adsorption, desorption and cooling processes are “moved” or shifted to adjacent vessels.

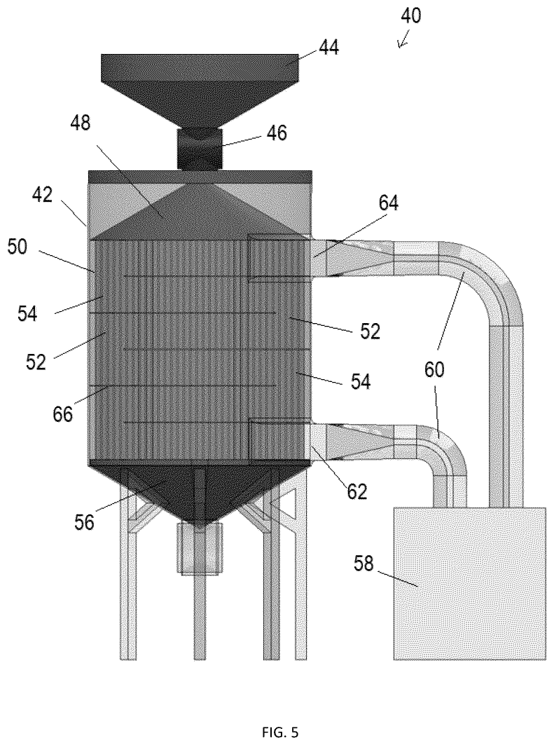

FIGS. 4A-4C depicts another example in which the system includes the plurality of vessels 24-1 through 24-5. In this example, the system is configured as a moving bed adsorption and desorption system. In this system, sorbent is moved among the vessels.

FIGS. 4A-4C show a state of the vessels at successive times during a carbon capture process. At the onset of the process, a solid sorbent is disposed in the vessels 24-1, 24-2 and 24-3.

At the first time t₁ (FIG. 4A), air 18 is directed to flow through the vessels 24-1, 24-2 and 24-3, and solid sorbent therein adsorbs carbon dioxide. The vessel 24-4 is configured as a desorption station, and if there is regenerated sorbent in the vessel 24-4, a heating gas and/or other source of thermal energy is applied to the vessel 24-4 to desorb and collect carbon dioxide. The vessel 24-5 is optional and functions as a cooling station.

At the time t₂ (FIG. 4B), sorbent from the vessel 24-1 is moved to the vessel 24-2, and sorbent from the vessel 24-2 is moved to the vessel 24-3. New sorbent may be introduced to the vessel 24-1. Movement of solid sorbent between vessels may be accomplished using any suitable mechanism or system, such as a conveyor system.

Also at the time t₂, sorbent from the vessel 24-3 is moved to the desorption vessel 24-4, and regenerated sorbent from the vessel 24-4 is optionally moved to the cooling vessel 24-5. Air is directed through the vessels 24-1, 24-2 and 24-3 for adsorption, heating gas and/or other thermal energy source is applied to the desorption vessel 24-4, and cooling gas or other cooling fluid is optionally circulated through the cooling vessel 24-5.

At the time t₃ (FIG. 4C), sorbent from the vessel 24-1 is moved to the vessel 24-2, and sorbent from the vessel 24-2 is moved to the vessel 24-3. New sorbent may be introduced to the vessel 24-1. Sorbent from the vessel 24-3 is moved to the desorption vessel 24-4, and regenerated sorbent from the vessel 24-4 is optionally moved to the cooling vessel 24-5. Adsorption, desorption and optional cooling processes are repeated as described herein.

At each successive time following time t₃, sorbent is moved to adjacent vessels, and the adsorption, desorption and cooling processes are repeated as desired.

FIG. 5 depicts an embodiment of a heat exchange system 40 configured to heat a solid sorbent to release captured material, such as carbon dioxide. The heat exchange system 40 may be coupled to a carbon capture or other capture system, such as the carbon capture system 10.

It is noted that, although the system 40 is described as a heat exchange and desorption system, the system is not so limited. For example, the system 40 may be used as an adsorption system by introducing a solid sorbent, circulating air therethrough and adsorbing CO2. The system 40 includes a vessel 42 (e.g., a desorption vessel 24) configured to hold a solid sorbent.

Solid sorbent may be disposed in the vessel in any suitable manner (e.g., via a feeder or conveyor system, manual or automatic insertion of batch sorbent, etc.). For example, the vessel 42 is connected to feed mechanism, such as a hopper 44 and valve assembly 46 (e.g., a rotary valve, double-dump airlock valve, etc.).

The hopper receives a solid sorbent 48 in a bulk solid (e.g., granular or pellet) form and feeds the solid sorbent 48 to the vessel 42, which houses a heat exchange assembly, referred to as a heat exchanger 50. The solid sorbent 48 is an any form that is suitable to allow the solid sorbent 48 to fall or otherwise move through the vessel 42.

In an embodiment, the solid sorbent 48 is in the form of a metal organic framework (MOF). The solid sorbent may be any suitable type of sorbent, such as MOF, zeolites, mesoporous silica, amine-impregnated, amine-functionalized solid sorbent and others (as well as combinations thereof). For example, saturated solid sorbent pellets (e.g., MOF pellets) are received from the drier 20. The pellets are heated via heat exchange with a thermal energy source. The pellets are heated as they travel through the heat exchanger 50, thereby releasing adsorbed carbon dioxide. The pellets may then be returned as regenerated MOF to the system 10 to be re-used for adsorption.

The heat exchanger 50 includes a plurality of passageways 52 that allow the solid sorbent to move through the vessel 42 (e.g., by gravity). The passageways 52 are made from a thermally conductive material (e.g., aluminum, steel, copper, ceramic, etc.) or other material having varying levels of thermal conductivity (e.g., plastic, ceramic, etc.). The passageways 52 are formed in any of various configurations that allow for heat exchange between the solid sorbent 48 and a fluid that is circulated through the vessel 42. Examples of such configurations include tube-and-shell and plate-and-shell configurations.

For example, the passageways 52 are formed by a plurality of vertically extending tubes 54. Each tube 54 has a size or diameter selected to allow solid sorbent pellets or granules to fall vertically through the heat exchanger 50 to a collector 56. As solid sorbent falls or moves through the passageways 52, the sorbent material may mix or roll-over and mix within the confines of a passageway 52. This mixing action may result in the majority of the solid sorbent having direct contact with the walls of the passageways, and increasing the conductive heat exchange and homogenization of the heat.

The collector 56 may be connected to a mechanism (e.g., the transport system 32 of FIG. 1) to return the solid sorbent 48 for re-use in carbon capture, or otherwise to transport the solid sorbent 48 to a desired location or system.

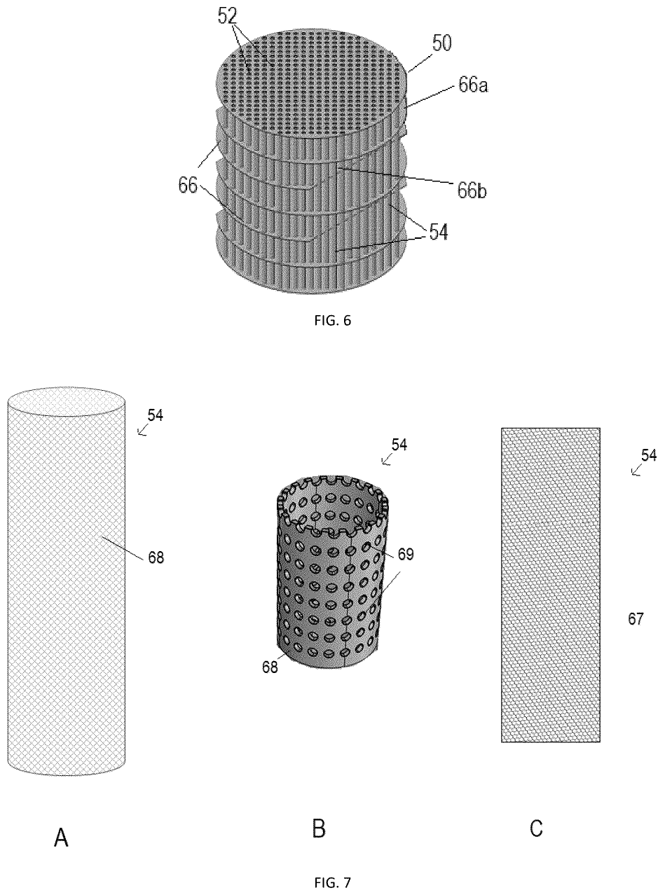

The heat exchanger 50 and the vessel 42 may have any suitable size and shape. For example, the heat exchanger is a cylindrical assembly as shown in FIG. 6. As shown, parts of at least some of the baffles include a portion 66a that forms a perpendicular surface with respect to the tubes 54, and a portion 66b that is inclined. In this way, a heating gas is caused to follow a generally meandering path from an upper region toward a lower region of the vessel 42 (or vice versa).

A thermal energy source, such as heated carbon dioxide gas (or other gas) is circulated or transmitted within the heat exchanger. A “thermal energy source” may be any material or energy source that causes the solid sorbent to change temperature. Examples of thermal energy sources includes gases, liquids, indirect conduction and electromagnetic energy (e.g., induction, microwaves or other radiofrequency (RF) energy, etc.). In an embodiment, electromagnetic energy is applied in conjunction with a circulating gas in the vessel 42.

In an embodiment, the thermal energy source is a heat exchange fluid such as high concentration carbon dioxide gas, which be under partial vacuum and less than atmospheric pressure. The heat exchange fluid is heated to a temperature above that of the solid sorbent 48 (e.g., via the drier 20), so that the solid sorbent 48 is heated to a temperature sufficient to cause release of adsorbed carbon dioxide. The carbon dioxide gas or other heat exchange fluid may be partially heated using low-grade heat or waste heat from the desorption process. This heat recovery reduces the net energy consumption of the desorption process.

The solid sorbent 48 is heated via a combination of conduction and convection. The system pressure may be maintained at a predetermined set point, allowing for released carbon dioxide to be bled from the system 40.

The released carbon dioxide may be removed from the vessel 42 via any suitable mechanism, such as via the circulated heat exchange fluid and/or pressure differential. For example, the system 40 includes a closed loop fluid circulation system that includes a chamber 58 containing a supply of a heat exchange fluid, such as carbon dioxide, and a means for recirculating the heat exchange fluid. Fluid conduits or ducts 60 are connected to the chamber 58 and to an interior of the vessel 42 via an inlet 62 and an outlet 64. As the heat exchange fluid is circulated and carbon dioxide is released, the pressure in the vessel 42 can be regulated or maintained by bleeding the circulation system.

The heat exchanger 50 may include features for directing the flow of the fluid or otherwise facilitating circulation. For example, the heat exchanger 50 includes a set of baffles 66 (e.g., the set of baffles 29) that function to direct the flow of the heat exchange fluid to maximize coverage and ensure that the heat exchange fluid is efficiently distributed among the tubes 54. As discussed above, the set of baffles 66 may be configured to cause the fluid to flow in a cross-flow path. For example, at least part of each baffle extends inwardly from a sidewall of the vessel 42 and forms a surface that is perpendicular to an axis of the tubes 54. The baffles 66 may also be used to circulate air if the system 40 is used for adsorption.

In an embodiment, all or some of the passageways 52 are bounded by a porous structure that is configured to allow at least some fluid circulating through the heat exchanger 50 to enter the passageways 52, or at least come into contact with the solid sorbent 48 as it moves through the passageways 52. In addition, any released gases can flow through the porous structure, allowing the released gases to be more efficiently removed from the heat exchanger 50.

For example, the porosity of the tubes 54 is configured to allow portions of the circulated carbon dioxide gas (heat exchange fluid) that impinge on the tubes 54 to flow into the passageways 53 and contact at least some of the solid sorbent pellets passing by. This contact serves to increase the rate of heat exchange as compared to conventional tube-and-shell heat exchangers and tube-and-plate heat exchangers that use solid tubes and plates to define solid sorbent passageways.

If the system 40 is used for adsorption, the porosity of the tubes 54 facilitates the adsorption process. For example, the porosity allows air to flow through the tubes 54 and effectively interact with the solid sorbent so that CO2 in the air is adsorbed.

For example, some or all of the tubes 54 have walls that have or include a porous structure, such as holes, a mesh, an open-cell foam type structure, etc. FIG. 7A shows an example of the tube 54 having a wall 68 formed as a mesh structure. FIG. 7B shows an example in which the porous structure is achieved by a plurality of holes 69 the extend through the wall 68. FIG. 7C is a cross-sectional view of an example of the tube 54, in which the tube walls have an open-cell porous structure 67. The tube may be formed of a combination of a mesh structure (such as shown in FIG. 7A) and a holed structure (such as shown in FIG. 7B, whereby the mesh and the holed structure are arranged as an assembly.

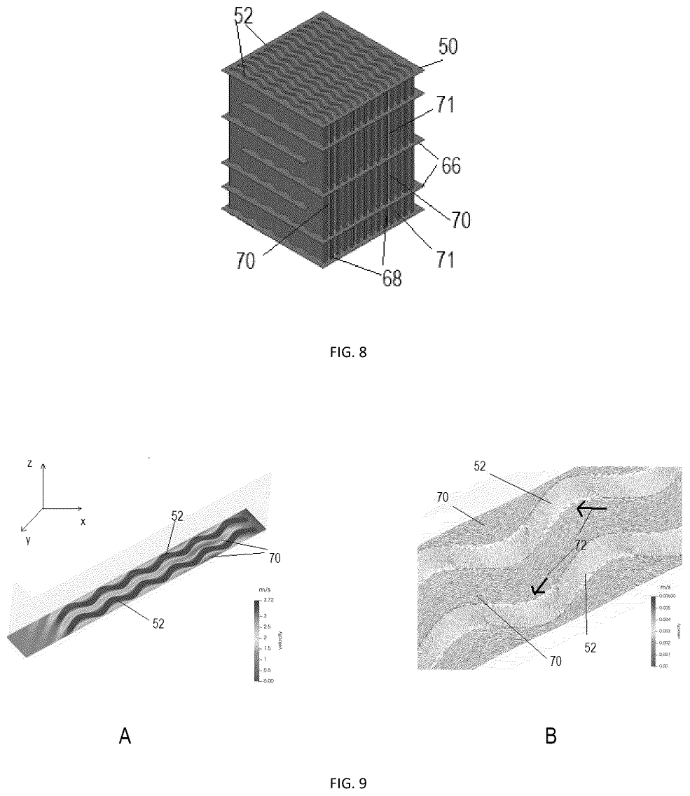

The heat exchanger 50 may be a cylindrical heat exchanger as shown in FIGS. 6 and 7, but is not so limited. In addition, the heat exchanger 50 may be a rectangular heat exchanger as shown in FIGS. 8 and 9, but is not so limited.

FIG. 8 shows an example of the heat exchanger 50 in a rectangular configuration. In this example, the heat exchanger 50 is a plate-and-shell heat exchanger, in which the solid sorbent passageways 52 are defined by sets of plates 71. The sets of plates 71 are arranged so that fluid channels 70 are defined between the sets of plates 71. The fluid channels 70 allow carbon dioxide gas or other heat exchange fluid to be circulated through the heat exchanger 50, and also provide paths for released carbon dioxide gas to be removed from the heat exchanger 50.

The sets of plates 71 may be configured to cause the fluid channels to follow any suitable path. For example, as shown in FIG. 8, the plates 71 have a non-linear configuration that facilitates thermal exchange between the solid sorbent 48 and the heat exchange fluid, by causing portions of the heat exchange fluid to change direction and flow toward the walls of the passageways 52. The non-linear configuration may follow a curved or snaking path, but can have any configuration that facilitates heat exchange as described herein. The heat exchanger 50 may use one or more tubes (e.g., the tube(s) 54) to define the non-linear path.

FIGS. 9A and 9B show an example of non-linear fluid channels 70, in the form of curved paths. In this example, the curved path has a sinusoidal geometry. Solid sorbent pellets fall vertically (in a direction parallel to a z-axis) through the passageways 52 as a heat exchange fluid flows in a direction that is generally orthogonal to the direction of movement of the solid sorbent pellets. The sinusoidal geometry acts to force some of the heat exchange fluid to penetrate into the passageways 52, thus improving heat exchange rates.

For example, as shown in FIG. 9B, as heat exchange fluid flows through a fluid channel 70, the heat exchange fluid is forced to change direction and flow toward the walls of the passageways 52, as illustrated by arrows 72. It is noted that the fluid channels 70 may define any non-linear paths that force a gas or fluid to locally change direction such that the gas or fluid has improved penetration as compared to a straight or liner path.

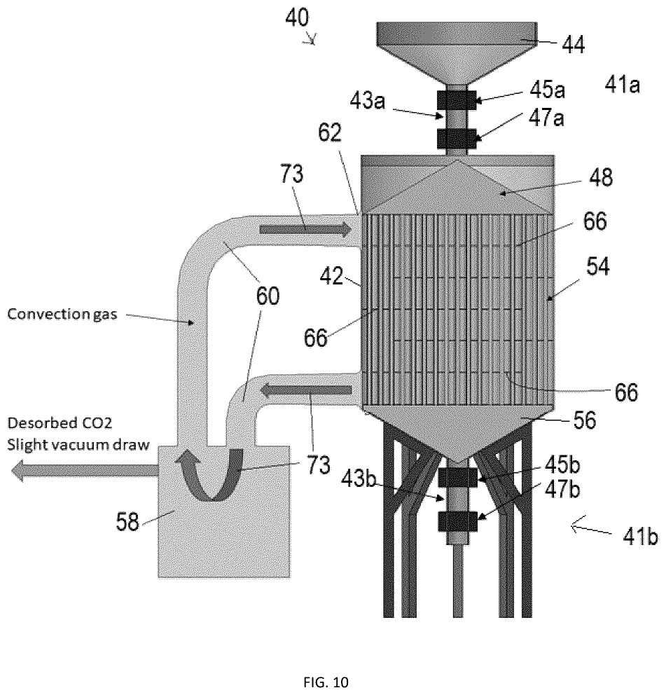

As noted above, the thermal energy source may be a fluid, gas or other material, or may be electromagnetic radiation or conduction. FIGS. 10, 11 and 12 depict examples of the system 40 as configured for use with different thermal energy sources. In these examples, the passageways 52 are defined by a plurality of vertical tubes 54. The wall of each tube has a porous structure as described herein. For example, each tube is a mesh tube. Although the system 40 is shown as having a tube porous structure, the system 40 may alternatively have a plate porous structure.

Also in these examples, the system 40 includes an airlock system having a set of airlock assemblies. The airlock assemblies include an input airlock assembly 41a and an output airlock assembly 41b. Although the system 40 is shown as having both assemblies, the system may alternatively have only one assembly (i.e., the input airlock assembly 41a or the output airlock assembly 41b).

The input airlock assembly 41a includes an airlock chamber 43a in fluid communication with the hopper 44. An upper valve 45a and a lower valve 47a are operable to isolate the airlock chamber from the hopper 44 and/or the vessel 42. The valves are controllable so that pressure in the vessel 42 can be maintained as the sorbent is introduced.

The output airlock assembly 41b includes an airlock chamber 43b in fluid communication with collector 56. An upper valve 45b and a lower valve 47b are operable to isolate the airlock chamber 43b from the collector 56 and/or the vessel 42, so that pressure in the vessel 42 can be maintained as the sorbent is removed or discharged.

FIG. 10 depicts an example in which heat exchange is achieved by flowing a heat exchange fluid, such as carbon dioxide gas 73, through the heat exchanger. In this example, solid sorbent 48 is introduced and moves downward by gravity toward the collector 56. A heat exchange fluid (e.g., hot gas having a temperature greater than a temperature of the solid sorbent) enters the inlet 62 and flows in a cross-flow pattern, guided by the baffles 66, with respect to the falling solid sorbent 48. Alternatively, the heat exchange fluid can be flowed in a counter-flow pattern. Desorbed gases combine into the heat exchange fluid stream and are evacuated through a recirculation loop to equalize system pressure. For example, a slight vacuum is used to draw some of the carbon dioxide gas 73 for collection, sequestration and/or storage. Regenerated sorbent 48 exits the bottom of the collector 56 and may be re-used.

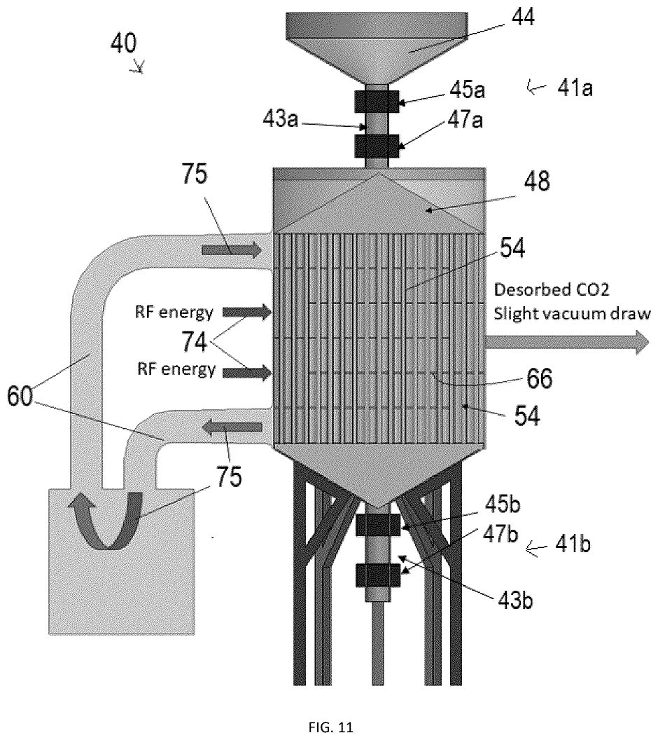

FIG. 11 depicts an example in which the solid sorbent is heated using electromagnetic or RF radiation, such as microwaves. In this example, the vessel 42 includes inlet waveguides (not shown) through which RF energy 74 is transmitted, and the RF energy may be directed by internal waveguides or other internal structure (not shown) to interact with the falling solid sorbent 48. Simultaneously, a convection fluid 75, such as carbon dioxide gas, is directed into the vessel 42 and guided by the baffles 66 to ensure even heat distribution. The convection fluid may be a heated fluid (heat exchange fluid) that provides an additional source of thermal energy. The tubes 54 in this example are also porous (e.g., mesh), which allows released carbon dioxide to be removed from the system 40 by a vacuum.

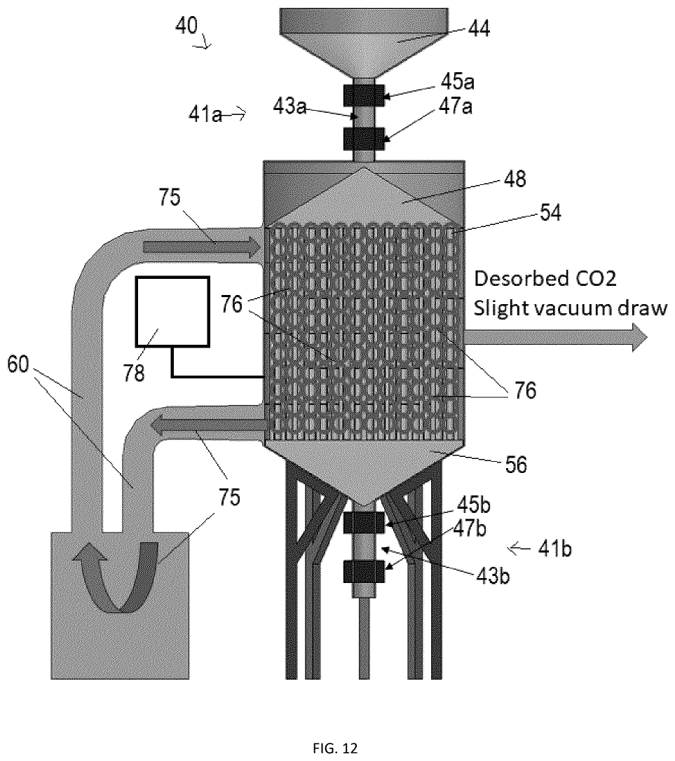

FIG. 12 depicts an example in which the solid sorbent is heated using electromagnetic energy via induction or by conduction. In this example, the vessel 42 includes a series of induction or conduction coils 76 surrounding each tube 54, which are connected to a power source or hot fluid supply. In use, an alternating current is applied to the induction coils 76 from a power source 78 to heat the porous tubes 54, or power is supplied to heat coils through electrical resistance. A hot fluid may be passed through the coils to heat the solid sorbent within the tubes 54. Carbon dioxide gas, or other convection fluid 75, is directed into the vessel 42 and guided by the baffles 66 to ensure even heat distribution, and optionally to provide additional heat.

### Set forth below are some embodiments of the foregoing disclosure:

Embodiment 1: A system, comprising: a vessel configured to receive a thermal energy source or air; and a plurality of passageways disposed in the vessel, the plurality of passageways configured to hold a solid sorbent, the plurality of passageways causing the thermal energy source to exchange heat with the solid sorbent, or causing the air to interact with the solid sorbent, wherein each passageway includes a wall having a porous structure configured to prevent the solid sorbent from passing through the wall while allowing a fluid to pass through the wall.

Embodiment 2: The system of any prior embodiment, wherein the thermal energy source is selected from at least one of: a heat exchange fluid, electromagnetic energy, and electrical resistive heating.

Embodiment 3: The system of any prior embodiment, wherein the porous structure is configured to allow the heat exchange fluid to pass through the wall and contact at least a portion of the solid sorbent.

Embodiment 4: The system of any prior embodiment, wherein the vessel includes a set of baffles configured to distribute a flow of the heat exchange fluid.

Embodiment 5: The system of any prior embodiment, wherein the set of baffles is a plurality of baffles configured to cause the heat exchange fluid to flow across the plurality of passageways.

Embodiment 6: The system of any prior embodiment, wherein the porous structure includes at least one of: a plurality of holes extending through the wall, an open-cell structure, and a mesh structure.

Embodiment 7: The system of any prior embodiment, wherein the plurality of fluid passageways are defined by at least one of: a plurality of tubes and a plurality of plates, wherein the plurality of plates and/or the plurality of tubes define fluid paths for the fluid, the fluid paths causing portions of the fluid to change direction such that the portions of the fluid are directed toward the walls of the plurality of passageways.

Embodiment 8: The system of any prior embodiment, wherein the solid sorbent is at least partially saturated with an adsorbed material, the heat exchanged between the solid sorbent and the thermal energy source causes release of the adsorbed material in a gaseous state, the porous structure configured to allow released material to pass through the wall for removal from the vessel.

Embodiment 9: A system for heat exchange, comprising: a vessel configured to receive a thermal energy source or air; and a plurality of passageways disposed in the vessel, the plurality of passageways configured to hold a solid sorbent, the plurality of passageways causing the thermal energy source to exchange heat with the solid sorbent, or causing the air to interact with the solid sorbent, the vessel including a set of baffles configured to distribute a flow of a convection fluid through the vessel.

Embodiment 10: The system of any prior embodiment, wherein the set of baffles is a plurality of baffles configured to cause the fluid to flow across the plurality of passageways.

Embodiment 11: The system of any prior embodiment, wherein the thermal energy source is selected from at least one of: a heat exchange fluid, electromagnetic energy, and electrical resistive heating.

Embodiment 12: The system of any prior embodiment, wherein the thermal energy source includes electromagnetic radiation, and the system includes a circulation system configured to direct the convection fluid into the vessel.

Embodiment 13: The system of any prior embodiment, wherein the thermal energy source includes inductive coils disposed within the vessel, and the system includes a circulation system configured to direct the convection fluid into the vessel.

Embodiment 14: The system of any prior embodiment, wherein the thermal energy source includes conductive surfaces within the vessel, and the system includes a circulation system configured to direct the convection fluid into the vessel.

Embodiment 15: The system of any prior embodiment, wherein each passageway includes a wall having a porous structure configured to prevent the solid sorbent from passing through the wall while allowing the convection fluid to pass through the wall.

Embodiment 16: A method, comprising: receiving a thermal energy source or air, and directing the thermal energy source or the air to an interior of a vessel, the vessel including a plurality of passageways, wherein each passageway of the plurality of passageways includes a wall having a porous structure configured to prevent a solid sorbent from passing through the wall while allowing a fluid to pass through the wall; and introducing a solid sorbent and holding the solid sorbent within the plurality of passageways and the vessel, the plurality of passageways causing the thermal energy source to exchange heat with the solid, or causing the air to interact with the solid sorbent.

Embodiment 17: The method of any prior embodiment, wherein the thermal energy source is selected from at least one of: a heat exchange fluid and electromagnetic energy and electrical resistive heating.

Embodiment 18: The method of any prior embodiment, wherein the porous structure is configured to allow the heat exchange fluid or the air to pass through the wall and contact at least a portion of the solid sorbent.

Embodiment 19: The method of any prior embodiment, wherein the thermal energy source includes a heat exchange fluid, the heat exchange fluid directed to the heat exchanger by injecting the heat exchange fluid into the vessel and circulating the heat exchange fluid through the vessel, such that heat is exchanged between the solid sorbent and the heat exchange fluid, wherein circulating the heat exchange fluid is facilitated by a set of baffles disposed in the vessel.

Embodiment 20: The method of any prior embodiment, wherein the heat exchange fluid is a gas, the solid sorbent is at least partially saturated with carbon dioxide, the heat exchanged between the solid sorbent and the gas causes release of the carbon dioxide, and the method includes evacuating the released carbon dioxide with the circulated gas, at least a portion of the released carbon dioxide flowing through the porous structure.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally”can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system, comprising:
a vessel configured to receive a thermal energy source or air; and
a plurality of passageways disposed in the vessel, the plurality of passageways configured to hold a solid sorbent, the plurality of passageways causing the thermal energy source to exchange heat with the solid sorbent, or causing the air to interact with the solid sorbent, wherein each passageway includes a wall having a porous structure configured to prevent the solid sorbent from passing through the wall while allowing a fluid to pass through the wall.

2. The system of claim 1, wherein the thermal energy source is selected from at least one of: a heat exchange fluid, electromagnetic energy, and electrical resistive heating.

3. The system of claim 2, wherein the porous structure is configured to allow the heat exchange fluid to pass through the wall and contact at least a portion of the solid sorbent.

4. The system of claim 2, wherein the vessel includes a set of baffles configured to distribute a flow of the heat exchange fluid.

5. The system of claim 4, wherein the set of baffles is a plurality of baffles configured to cause the heat exchange fluid to flow across the plurality of passageways.

6. The system of claim 1, wherein the porous structure includes at least one of: a plurality of holes extending through the wall, an open-cell structure, and a mesh structure.

7. The system of claim 1, wherein the plurality of fluid passageways are defined by at least one of: a plurality of tubes and a plurality of plates, wherein the plurality of plates and/or the plurality of tubes define fluid paths for the fluid, the fluid paths causing portions of the fluid to change direction such that the portions of the fluid are directed toward the walls of the plurality of passageways.

8. The system of claim 1, wherein the solid sorbent is at least partially saturated with an adsorbed material, the heat exchanged between the solid sorbent and the thermal energy source causes release of the adsorbed material in a gaseous state, the porous structure configured to allow released material to pass through the wall for removal from the vessel.

9. A system for heat exchange, comprising:
a vessel configured to receive a thermal energy source or air; and
a plurality of passageways disposed in the vessel, the plurality of passageways configured to hold a solid sorbent, the plurality of passageways causing the thermal energy source to exchange heat with the solid sorbent, or causing the air to interact with the solid sorbent, the vessel including a set of baffles configured to distribute a flow of a convection fluid through the vessel.

10. The system of claim 9, wherein the set of baffles is a plurality of baffles configured to cause the fluid to flow across the plurality of passageways.

11. The system of claim 9, wherein the thermal energy source is selected from at least one of: a heat exchange fluid, electromagnetic energy, and electrical resistive heating.

12. The system of claim 9, wherein the thermal energy source includes electromagnetic radiation, and the system includes a circulation system configured to direct the convection fluid into the vessel.

13. The system of claim 9, wherein the thermal energy source includes inductive coils disposed within the vessel, and the system includes a circulation system configured to direct the convection fluid into the vessel.

14. The system of claim 9, wherein the thermal energy source includes conductive surfaces within the vessel, and the system includes a circulation system configured to direct the convection fluid into the vessel.

15. The system of claim 9, wherein each passageway includes a wall having a porous structure configured to prevent the solid sorbent from passing through the wall while allowing the convection fluid to pass through the wall.

16. A method, comprising:
receiving a thermal energy source or air, and directing the thermal energy source or the air to an interior of a vessel, the vessel including a plurality of passageways, wherein each passageway of the plurality of passageways includes a wall having a porous structure configured to prevent a solid sorbent from passing through the wall while allowing a fluid to pass through the wall; and
introducing a solid sorbent and holding the solid sorbent within the plurality of passageways and the vessel, the plurality of passageways causing the thermal energy source to exchange heat with the solid, or causing the air to interact with the solid sorbent.

17. The method of claim 16, wherein the thermal energy source is selected from at least one of: a heat exchange fluid and electromagnetic energy and electrical resistive heating.

18. The method of claim 17, wherein the porous structure is configured to allow the heat exchange fluid or the air to pass through the wall and contact at least a portion of the solid sorbent.

19. The method of claim 16, wherein the thermal energy source includes a heat exchange fluid, the heat exchange fluid directed to the heat exchanger by injecting the heat exchange fluid into the vessel and circulating the heat exchange fluid through the vessel, such that heat is exchanged between the solid sorbent and the heat exchange fluid, wherein circulating the heat exchange fluid is facilitated by a set of baffles disposed in the vessel.

20. The method of claim 19, wherein the heat exchange fluid is a gas, the solid sorbent is at least partially saturated with carbon dioxide, the heat exchanged between the solid sorbent and the gas causes release of the carbon dioxide, and the method includes evacuating the released carbon dioxide with the circulated gas, at least a portion of the released carbon dioxide flowing through the porous structure.
